(19) United States
(12) Patent Application Publication
(10) Pub. No.: US 2011/0080334 A1
(43) Pub. Date: Apr. 7, 2011

(54) VISUAL IMAGE DISPLAY APPARATUSES AND METHODS

(76) Inventor: Jong-Souk Yeo, Corvallis, OR (US)

(21) Appl. No.: 12/572,174

(22) Filed: Oct. 1, 2009

(51) Int. Cl. G09G 3/20; H01R 43/00

(52) U.S. Cl. 345/55; 29/825

(57) ABSTRACT

Visual image display apparatuses and visual image display apparatus fabrication methods are described. According to one arrangement, a visual image display apparatus includes a front plane comprising a display system configured to generate a plurality of visual images as a result of a plurality of electrical control signals and an interconnect apparatus adjacent to the display system and which comprises an electrically-insulative substrate and a plurality of electrical conductors within the electrically-insulative substrate, and wherein the electrical conductors are configured to conduct the electrical control signals with respect to the display system to control the generation of the visual images.

### BACKGROUND

Many different types of display systems capable of generating visual images have been developed for use in an ever-increasing number of applications. Electro-optical displays have been developed for use, for example, in personal electronic devices, such as electrical books in one application. Example arrangements of electro-optical displays are described in a co-pending U.S. patent application entitled “Electro-Optical Display,” having Ser. No. 12/411,828, filed Mar. 26, 2009, naming Jong-Souk Yeo, Gregg Alan Combs, Jeffrey Todd Mabeck, Tim R. Koch, Pavel Kornilovich, and Donald Milton Hill as inventors, and assigned to the assignee hereof.

There have been challenges in fabrication of visual image display systems. Fabrication of image generating portions of a display system including a plurality of display elements with or upon associated circuitry configured to control the display systems may result in relatively low yield in part due to the number of steps involved with forming the control circuitry and the display elements as integral devices. Further complicating fabrication is that some fabrication steps may be performed in different fabrication systems or be performed by different vendors.

At least some aspects of the disclosure pertain to improved visual image display apparatuses and improved fabrication methods and operational methods.

### DESCRIPTION OF DRAWINGS

FIG. 1 is an illustrative representation of a visual image display apparatus according to one embodiment.

FIG. 2 is a functional block diagram of circuitry and components of a visual image display apparatus according to one embodiment.

FIG. 3 is a cross-sectional view of a portion of a display assembly according to one embodiment.

FIG. 3A is a cross-sectional view of a portion of a display assembly according to one embodiment.

FIG. 4 is a plan view of a portion of a display assembly according to one embodiment.

FIG. 5 depicts cross-sectional views of acts of forming an interconnect apparatus according to one embodiment.

FIG. 6 depicts cross-sectional views of acts of forming an interconnect apparatus according to one embodiment.

FIG. 7 depicts cross-sectional views of acts of forming an interconnect apparatus according to one embodiment.

FIG. 8 depicts cross-sectional views of acts of forming an interconnect apparatus according to one embodiment.

FIG. 9 is a flow chart depicting a method of forming a display assembly according to one embodiment.

### DETAILED DESCRIPTION

At least some embodiments of the disclosure relate to visual image display apparatuses. The display apparatuses may be configured as electro-optical displays described in the above-referenced patent application in one example. Additional embodiments of the disclosure provide methods of fabricating and operating the visual image display apparatuses. The visual image display apparatuses individually include a display system which comprises a front plane comprising a plurality of display elements (e.g., pixels) which are controlled to operate in a plurality of different states to form visual images. The display system also includes a back plane configured to conduct electrical control signals with respect to the front plane to control the generation of the images. In one example embodiment, the front and back planes may be separately fabricated and bonded to one another to form a display system. In one more specific example, a through-hole interconnect may be used to conduct the electrical control signals from the back plane to the display elements of the front plane. Other embodiments and aspects are described herein.

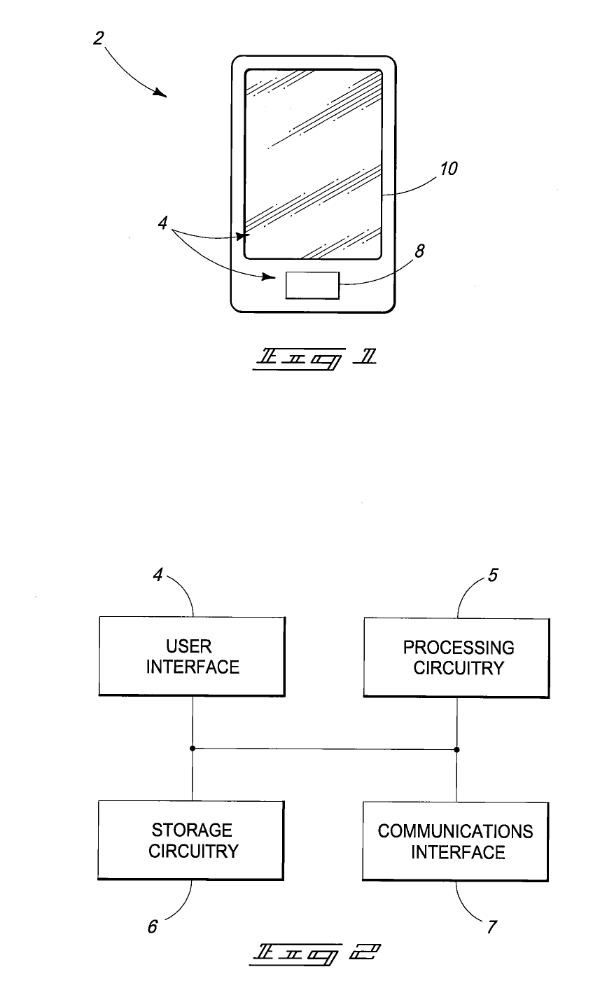

Referring to FIG. 1, a visual image display apparatus 2 is shown according to one embodiment. Apparatus 2 is configured to generate visual images for observation by a user. In one possible configuration, apparatus 2 is implemented as an electronic book configured to depict images representing pages of a book. For example, the generated visual images may include text and/or images. This is only one illustrative example and other configurations and applications of use of apparatus 2 are possible.

In the depicted example configuration, apparatus 2 includes a user interface 4 which is configured to interact with a user. In one embodiment, the user interface 4 includes a display assembly 10 configured to generate the visual images which may be observed by a user and an input device 8 which may receive user inputs for controlling operations of apparatus 10, for example, enabling the user to control which images are depicted using the display apparatus 10.

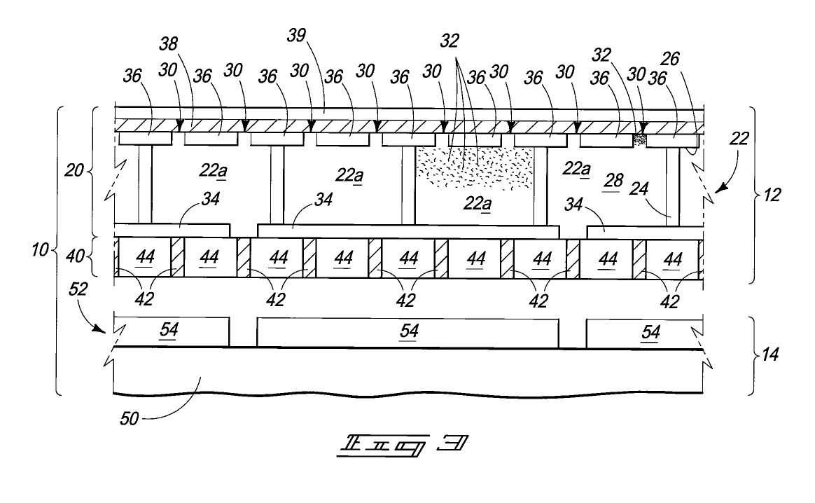

Referring to FIG. 2, an example configuration of components and circuitry of apparatus 2 is shown. In the depicted example, apparatus 2 includes user interface 4, processing circuitry 5, storage circuitry 6 and a communications interface 7. Other embodiments are possible including more, less or alternative components.

In one embodiment, processing circuitry 5 is arranged to process data, control data access and storage, control the generation of visual images via the display assembly 10 and control other desired operations. Processing circuitry 5 may comprise circuitry configured to implement desired programming provided by appropriate media in at least one embodiment. For example, the processing circuitry may be implemented as one or more of processor(s) and/or other structure configured to execute executable instructions including, for example, software and/or firmware instructions, and/or hardware circuitry. Exemplary embodiments of processing circuitry 5 include hardware logic, PGA, FPGA, ASIC, state machines, and/or other structures alone or in combination with a processor. These examples of processing circuitry are for illustration and other configurations are possible.

The storage circuitry 6 is configured to store programming such as executable code or instructions (e.g., software and/or firmware), electronic data, databases, data regarding images to be displayed or other digital information and may include processor-usable media. Processor-usable media may be embodied in any computer program product(s) or article of manufacture(s) which can contain, store, or maintain programming, data and/or digital information for use by or in connection with an instruction execution system including processing circuitry 5 in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

At least some embodiments or aspects described herein may be implemented using programming stored within appropriate storage circuitry 6 described above and configured to control appropriate processing circuitry 5. For example, programming may be provided via appropriate media including, for example, embodied within articles of manufacture.

Communications interface 7 is arranged to implement communications of apparatus 2 with respect to external devices and networks (not shown). For example, communications interface 7 may be arranged to communicate information bi-directionally with respect to apparatus 2. Communications interface 7 may be implemented as a serial or parallel connection, USB port, Firewire interface, flash memory interface, floppy disk drive, or any other suitable arrangement for communicating with respect to apparatus 2.

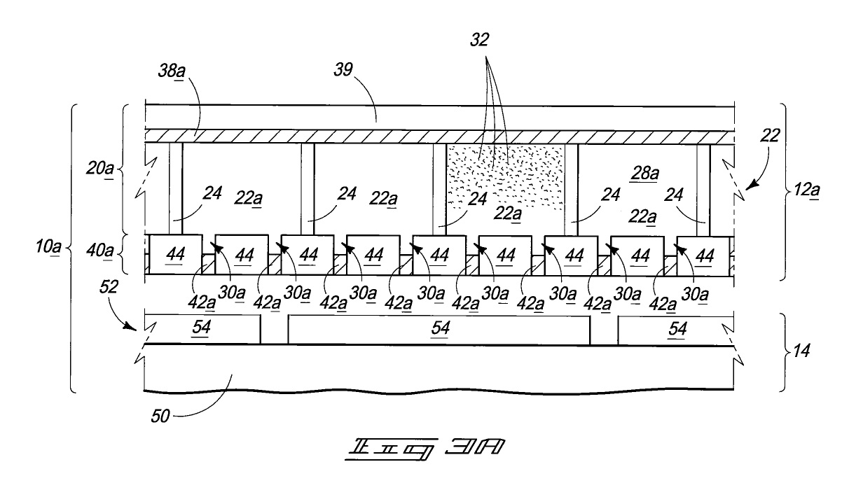

Referring to FIG. 3, one embodiment of a display apparatus 10 is shown. The depicted configuration of display assembly 10 includes a front plane 12 and a back plane 14. Front plane 12 is configured to generate the visual images which may be observed by a user and back plane 14 comprises circuitry configured to provide signals to control the generation of the visual images by the front plane 12. Example back planes 14 include direct driven pixel plate arrays, passive matrix arrays or active matrix pixel arrays in illustrative embodiments. In one embodiment, front plane 12 is configured as an electro-optical display as described in the above-mentioned patent application. Other display configurations may be used in other embodiments.

In the depicted arrangement, front plane 12 includes a display system 20 and an interconnect apparatus 40. Display system 20 is configured to generate the visual images of the display assembly 10 as a result of electrical control signals conducted by back plane 14 and interconnect apparatus 40. Back plane 14 is coupled with interconnect apparatus 40 in one embodiment and back plane 14 applies electrical control signals to interconnect apparatus 40 which conducts the electrical control signals with respect to display system 20. Back plane 14 may receive the electrical control signals from processing circuitry 5 in one embodiment.

Display system 20 is configured to generate a plurality of visual images as a result of the electrical control signals. Display system 20 includes a display volume 22 in the depicted embodiment. Display volume 22 may be filled with a display medium which includes a plurality of colorants 32 such as colorant particles or colorant fluids (e.g., dyes). A plurality of containment walls 24 are shown in the illustrated embodiment which separate upper and lower portions of the display system 20 and define the display volume 22. The containment walls 24 define a plurality of portions 22a of the display volume 20. The portions 22a may be isolated from one another or in fluid communication with one another. Only one of the portions 22a includes colorants 32 in the illustration of FIG. 3 although all of the portions 22a may contain the display medium and colorants 32 in typical configurations.

The display medium may be a carrier fluid, such as a polar fluid (e.g., water), non-polar fluid (e.g., dodecane), or anisotropic fluid (e.g., liquid crystal) in illustrative embodiments. The fluid may include one or more of salts, charging agents, stabilizers and dispersants in some embodiments. In one example, the colorants 32 move between different regions of the display volume to generate the visual images as described below. The colorants 32 comprise electrically charged material in one embodiment where the display system 20 is configured as an electro-convective or electrokinetic display.

The display system 20 also includes a plurality of conductors 34 adjacent to one end of a periphery 26 of the display volume 22 and a plurality of dielectric structures 36, and a conductor 38 adjacent to an opposite end of the periphery 26 of the display volume 22 as shown in FIG. 3. Conductors 34, 38 may comprise modulating electrodes which are in direct contact with and provide charge transfer with the display medium in the illustrated embodiment. Electrical control signals may be applied to conductors 34, 38 to control the movement of the colorants 32 and the generation of visual images in one embodiment. This example of display system 20 may be used in electro-wetting, electrofluidic, electro-connective or electrokinetic displays in some configurations.

In one embodiment, the colorants 32 may be electrically charged. Accordingly, application of electrical control signals having different biasing voltages to conductors 34, 38 may control movement of the colorants 32 between different locations or portions within the display medium of the display volume 22. The periphery 26 of display volume 22 includes a main portion 28 and a plurality of recess portions 30 in the illustration of FIG. 3. If the colorants 32 are negatively-charged, and a negatively-biased electrical control signal is applied to conductor 38 while a positively biased control signal is applied to one of the electrical conductors 34, then the colorants 32 in the respective portion(s) 22a move into a region of the main portion 28 of the display volume 22 which corresponds to the respective electrical conductor 34 receiving the positively biased control signal. This is referred to as a colored state where the colorants 32 are relatively uniformly dispersed with the region of the main portion 28 of the display volume 22 corresponding to the positively-biased conductor 34 to absorb or scatter the incident light and create a colored optical appearance.

Furthermore, if the polarity of the electrical control signals applied to the respective conductor 34 and conductor 38 is reversed, the respective colorants 32 adjacent to the negatively-biased electrical conductor are pushed to the positively-charged conductor 38 and compacted within a respective one of the recessed regions 30 and the respective region of the main portion 28 of the display volume 22 is cleared of the colorants 32 providing a display element adjacent to the negatively-biased electrical conductor having a clear state which transmits incident light. The colored and clear optical states of plural display elements corresponding to conductors 34 are controlled by processing circuitry 5 to form the visual images in one embodiment.

Any appropriate arrangement may be used to provide different relative potentials between conductors 34, 38 to control the pixels between the colored and clear states. For example, one of the conductors 34, 38 may be grounded and positive and negatively-biased control signals may be provided to the other of the conductors to provide colored and the clear states in one possible example.

The display system 20 includes a plurality of display elements (e.g., pixels) defined by the electrical conductors 34 and which are separately controllable between the colored and clear states to generate the visual images in one embodiment. In the example of FIG. 3, a plurality of recess portions 30 and respective regions of the main portion 28 of the display volume 22 correspond to individual display elements. For example, all of the recess portions 30 and respective regions of the main portion 28 of the display volume 22 above one of the conductors 34 correspond to a display element and such recess portions 30 and respective regions of the main portion 28 are simultaneously provided in one of the colored and clear states responsive to the control signals to form images. In one embodiment, a plurality of conductors 42 (discussed below) coupled with one of the conductors 34 each conduct the electrical control signal for one of the display elements.

According to the example described embodiment, the electrical control signals may be configured to cause some colorants 32 to be within recess portions 30 of some of the display elements (e.g., the right-most recess portion 30 corresponding to one pixel in a clear state in FIG. 3) while other colorants 32 may be within respective regions of the main portion 28 of the display volume 22 corresponding to others of the display elements (e.g., the illustrated dispersed colorants in main portion 28 in FIG. 3 corresponding to another pixel in a colored state) to form visual images. Accordingly, depending upon the biasing of the various conductive structures 34, 38, one region of the main portion 28 of display volume 22 corresponding to a display element may be colored and an adjacent region of the main portion 28 corresponding to a display element may be clear based upon control signals provided by the processing circuitry 5.

One of the electrical conductors 34, 38 may be transparent and the other of the electrical conductors 34, 38 may be opaque in one configuration. In another configuration, both of the electrical conductors 34, 38 are transparent. Example transparent conductive material of one or both of the conductors 34, 38 includes carbon nanotube layers, a transparent conducting oxide such as ITO (Indium Tin Oxide), or a transparent conducting polymer such as PEDOT (poly3,4-ethylenedioxythiophene). Dielectric structures 36 may also be transparent in one embodiment.

The display system 20 also includes a transparent layer 39 over electrical conductor 38 in the illustrated embodiment. The transparent layer 39 may comprise transparent inorganic materials such as glass or transparent organic materials such as polyethylene terephthalate (PET) in some examples.

In one configuration, containment walls 24 are fabricated by embossing techniques. In one example, a layer of a photocurable and/or embossable material (e.g., a base resin such as a low viscosity aliphatic urethane diacrylate with a photo initiator (e.g. 1,6-hexanediol diacrylate) and adhesion promoter (e.g. Monofunctional acid ester) in one embodiment) may be provided upon the conductors 34 and a suitable master having recesses corresponding to the containment walls 24 may be inserted into the layer of resin and the resin may be thereafter cured to form the containment walls 24.

Other configurations apart from the example arrangement of FIG. 3 are possible. For example, conductors 34, 38 may have different configurations than the illustrated arrangements of FIG. 3. In one example, both conductors 34, 38 may be blanket conductors similar to conductor 38 shown in FIG. 3. In another embodiment, both conductors 34, 38 may comprise a plurality of respective structures similar to the conductors 34 shown in FIG. 3. In yet another embodiment, conductor 34 may be a blanket conductor and conductor 38 may include a plurality of conductive structures. In addition, dielectric material may also be provided upon the lower portion of the display system 20 and the illustrated dielectric 36 may be included or omitted. In some embodiments, recess portions 30 may be formed upon the lower portion of the display system 20. A plurality of alternative embodiments are described in the above-referenced patent application and which may be utilized in other front plane configurations.

In addition, colorants 32 of the display volume may have a common color in one embodiment. Some arrangements of display apparatus 10 are monochrome and the colorants 32 may be black or spot colors of interest in one embodiment. Other arrangements of display apparatus 10 are color and display system 20 may include a plurality of display volumes 22 stacked atop one another as described in the patent application referred to above. Display system 20 may be configured in any of the disclosed arrangements of the above-referenced patent application.

As mentioned above, the embodiment of display assembly 10 shown in FIG. 3 includes an interconnect apparatus 40. The interconnect apparatus 40 comprises a through-hole interconnect in the depicted example arrangement of FIG. 3. The through-hole interconnect includes a plurality of through-hole electrical conductors 42 within vias of an electrically-insulative substrate 44. The conductors 42 conduct electrical control signals between upper and lower surfaces of interconnect apparatus 40 in one embodiment. The upper and lower surfaces are substantially planar in one embodiment to facilitate coupling of interconnect apparatus 40 with display system 20 and/or back plane 14 or facilitate formation of display system 20 upon interconnect apparatus 40.

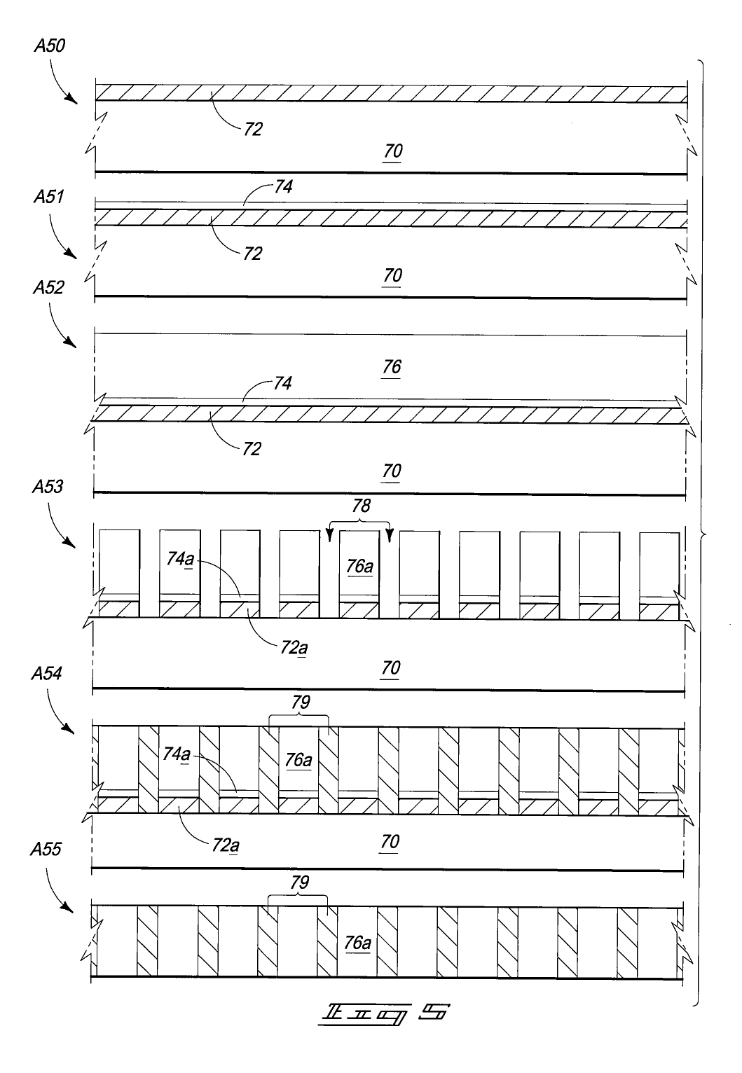

Vias may be formed during the formation of substrate 44 or after substrate 44 is formed (e.g., using molding, embossing, machining, photolithography or etching processes). Electrical conductors 42 may be formed by metal deposition (e.g., electro-plating, atomic layer deposition) or using a patternable conductive polymer coating process in example arrangements. Through-hole electrical conductors 42 individually have a relatively small diameter (e.g., <50 μm in one example and within a range of 5-20 μm in a more specific example) to provide a substantially transparent interconnect apparatus 40 (e.g., 70-98% transparent in one example and 90-95% transparent in a more specific example) in one embodiment. In the illustrated embodiment, interconnect apparatus 40 operates to conduct electrical control signals from back plane 14 to the display system 20. A plurality of example methods of forming the interconnect apparatus 40 in the form of a through-hole interconnect are described with respect to FIGS. 5-8.

In some embodiments, the display system 20 and interconnect apparatus 40 may be fabricated separately and thereafter aligned and bonded to one another, for example using an adhesive layer or the substrate 44, to form the front plane 12. In another embodiment, the interconnect apparatus 40 is formed and the display system 20 is formed upon the interconnect apparatus 40. In yet another embodiment, the display system 20 is initially formed and the interconnect apparatus 40 is thereafter formed upon the display system 20. In one embodiment, the bonding of the display system 20 and interconnect apparatus 40 forms the front plane 12 as an integrated, free-standing member which may be thereafter coupled with a back plane 14.

In the illustrated arrangement, back plane 14 includes a substrate 50 and an array 52 of electrical conductors 54. In one configuration, the array 52 may be referred to as a pixel array and electrical conductors 54 may be referred to as pixel plates. Electrical conductors 54 are coupled with electrical conductors 42 of the interconnect apparatus 40 within the display assembly 10. In one embodiment, the electrical conductors 54 transmit electrical control signals to the electrical conductors 42.

In one embodiment, the front plane 12 is formed separately from back plane 14 and the front plane 12 and the back plane 14 may be subsequently joined to form the display assembly 10. In such an embodiment, the front plane 12 may be designed and manufactured and thereafter joined with different configurations of available back planes 14. In yet another embodiment, the front plane 12 and back plane 14 may be formed upon one another.

In one embodiment, electrically-insulative substrate 44 is substantially transparent. Also, substrate 44 may be used to bond the front and pack planes 12, 14 together in one arrangement. In one example, substrate 44 comprises glass, plastic or an electrically-insulative photoresist which bonds with the back plane 14. In a more specific example, substrate 44 is a photopolymerizable polymeric layer such as a dry film (e.g., SU-8 photoresist described in U.S. Pat. No. 4,882,245).

Referring to FIG. 3A, another embodiment of display assembly 10a is shown. The illustrated arrangement of display assembly 10a includes a display system 20a and an interconnect apparatus 40a. In the illustrated embodiment, the recess portions 30a configured to receive the compacted colorants 32 during clear states of operation are provided at the bottom portion of the display system 20a. As shown, the interconnect apparatus 40a defines the recess portions 30a of the display volume 22. More specifically, the through-hole electrical conductors 42a only partially fill the respective vias thereby forming the recess portions 30a. The electrical conductors 42a are provided adjacent to recess portions 30a in the example of FIG. 3A. In addition, the electrical conductor 38a at the upper portion of the display system 20a is a blanket conductor in the illustrated embodiment. The electrical conductors 42a only partially filling the vias and adjacent to the recess portions 30a operate as charge transfer probes and optical absorbers (black masks) as well as through-hole electrical conductors that couple with back plane conductors.

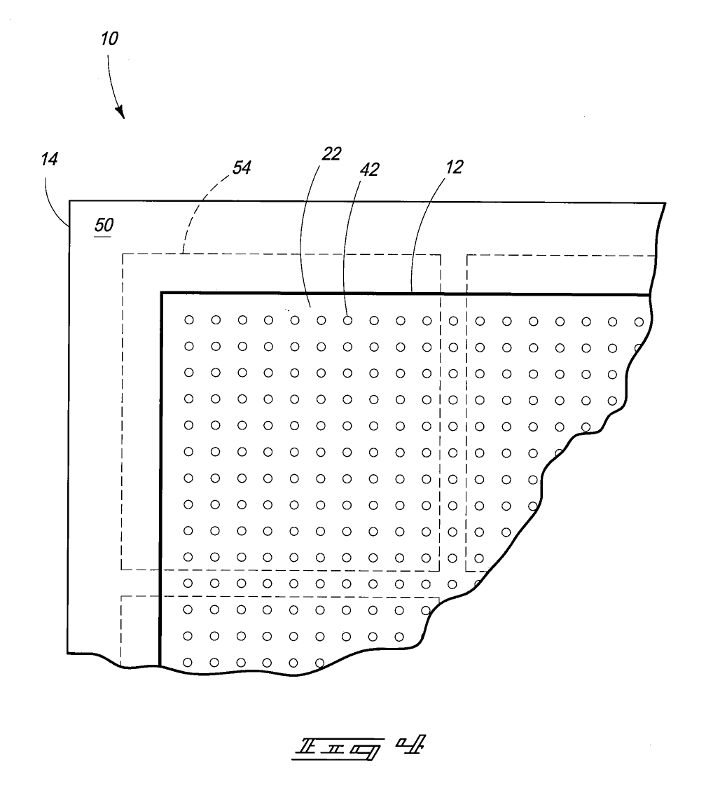

Referring to FIG. 4, a plan view of one embodiment of the display assembly 10 is shown. FIG. 4 illustrates an example pitch of electrical conductors 42 of front plane 12 and an example pitch of electrical conductors 54 of back plane 14. More specifically, the pitch of at least some of the electrical conductors 42 is less than the pitch of at least some of the electrical conductors 54 in the illustrated example to attempt to alleviate problems arising from misalignment of front plane 12 and back plane 14 during fabrication of the display assembly 10 (i.e., illustratively represented by the space between the upper left corners of front plane 12 and back plane 14) and to increase yield of resultant display systems 20. In particular, even in the presence of some misalignment of front and back planes 12, 14, individual ones of the electrical conductors 54 of back plane 14 are contacted by at least some of the electrical conductors 42 of front plane 12 providing an operable device even with the misalignment. Furthermore, the number of electrical conductors 42 coupled with electrical conductors 54 exceeds the number of electrical conductors 54 coupled with electrical conductors 42 in one embodiment. In one embodiment, each of the electrical conductors 54 is coupled with at least one of the electrical conductors 42 even in the presence of misalignment of front and back planes 12, 14.

The through-hole electrical conductors 42 are shown substantially uniformly distributed across the front plane 12 in the depicted example. In other embodiments, the through-hole electrical conductors 42 are not evenly distributed and different regions of the front plane 12 may comprise different numbers of through-hole electrical conductors 42 in one embodiment. In addition, the number of electrical conductors 42 may be the same as the number of electrical conductors 54 in one embodiment.

A plurality of methods of forming interconnect apparatus 40 are described with respect to FIGS. 5-8. The depicted methods are used to form the interconnect apparatus 40 comprising a through-hole interconnect according to some embodiments. Other fabrication processes are possible in other embodiments. For example, in other embodiments, more, less or alternative acts may be performed in any of the methods of FIGS. 5-8.

Referring to FIG. 5, the illustrated process includes providing a carrier 70, such a wafer or plastic carrier, with a metal layer 72, such as stainless steel, thereon at an act A50. Metal layer 72 assists with the release of subsequently-formed structures from carrier 70 and is used to implement electroplating of metal to form electrical conductors 42 in one embodiment.

At an act A51, a release layer 74, such as TF-800 thick film resist available from Rohm and Haas Electronic Materials LLC, is deposited upon metal layer 72 and is also configured to assist with release of subsequently-formed structures from carrier 70.

At an act A52, a transparent photopolymer or photoresist (e.g., SU-8) layer 76 is formed, for example by spin coating, upon release layer 74.

At an act A53, the transparent layer 76a is patterned (e.g., using a mask not shown) to form a plurality of vias 78. The metal layer 72a and release layer 74a may also be patterned as shown.

At an act A54, the assembly undergoes a metal plating process (e.g., nickel or copper in illustrated examples) to form a plurality of electrical conductors 79 in the vias 78. The electrical conductors 79 correspond to electrical conductors 42 of FIG. 3 in one embodiment.

At an act A55, the assembly may be released from the carrier 70 and layers 72a, 74a thereon. In one embodiment, a suitable etchant (e.g., Tetramethylammonium hydroxide (TMAH)) is used to etch the release layer 74 to release the assembly including the photoresist layer 76a and the electrical conductors 79 from carrier 70 providing a free-standing layer. The released assembly of act A55 corresponds to interconnect apparatus 40 of FIG. 3 in one embodiment. In other embodiments, additional layers of the front plane 12 may be formed upon interconnect apparatus 40 while processing occurs upon carrier 70.

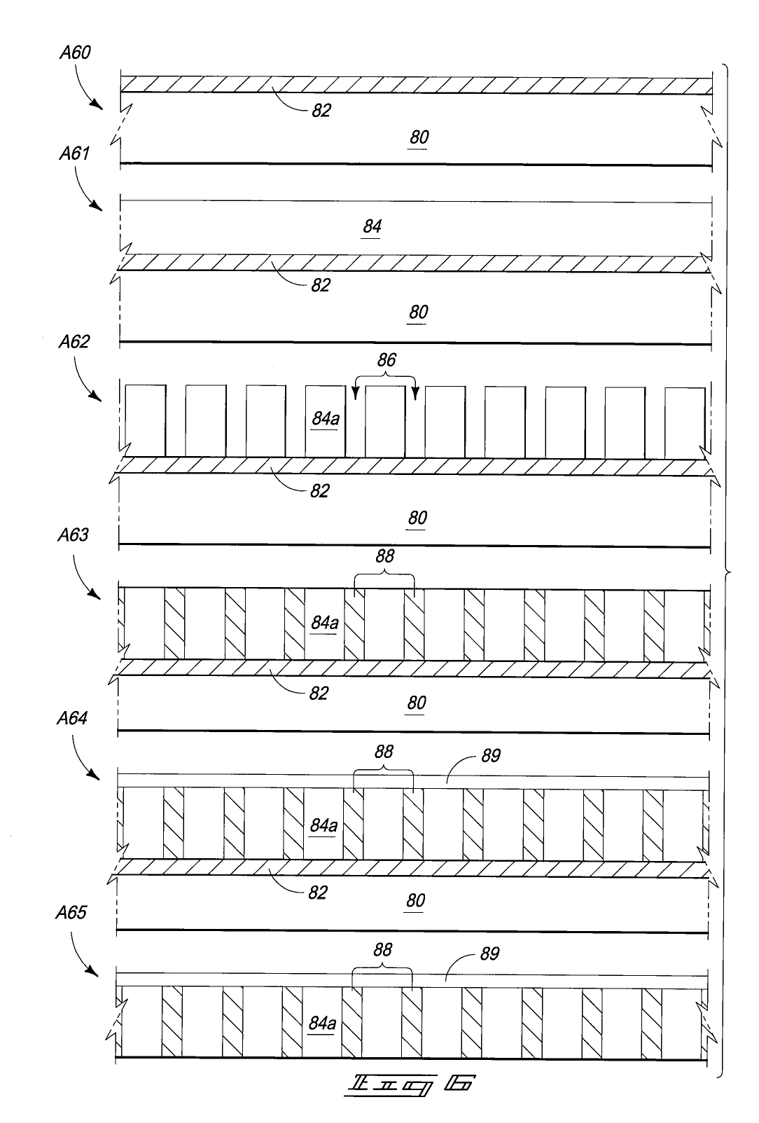

Referring to FIG. 6, the illustrated process includes providing a rigid or flexible carrier 80 at an act A60. The carrier 80 has a metal layer 82, such as stainless steel, thereon to assist with the release of subsequently-formed structures from carrier 80 and which is used to implement electroplating of metal to form electrical conductors 42 in one embodiment.

At an act A61, an embossing resin layer 84 is formed upon metal layer 82, for example, using the photocurable and/or embossable material discussed above in one embodiment.

At an act A62, the embossing resin layer 84 is embossed with a suitable master (now shown) to form a plurality of vias 86 within the embossing resin layer 84a over metal layer 82.

At an act A63, the assembly undergoes a metal plating process (e.g., Nickel in one example) to form a plurality of electrical conductors 88 in the vias 86 over metal layer 82. The electrical conductors 88 correspond to electrical conductors 42 of FIG. 3 in one embodiment.

At an act A64, a thin layer 89 of a transparent electrically-conductive material (e.g., ITO) is deposited upon the assembly. The layer 89 corresponds to the electrical conductor(s) 34 of FIG. 3 in one embodiment.

At an act A65, the assembly may be released from the carrier 80 and layer 82 thereon. The released assembly of act A65 corresponds to interconnect apparatus 40 including the lower electrical conductor(s) 34 of the display system 20 in one embodiment. In other embodiments, additional layers of the front plane 12 may be formed upon interconnect apparatus 40 while processing occurs upon carrier 80.

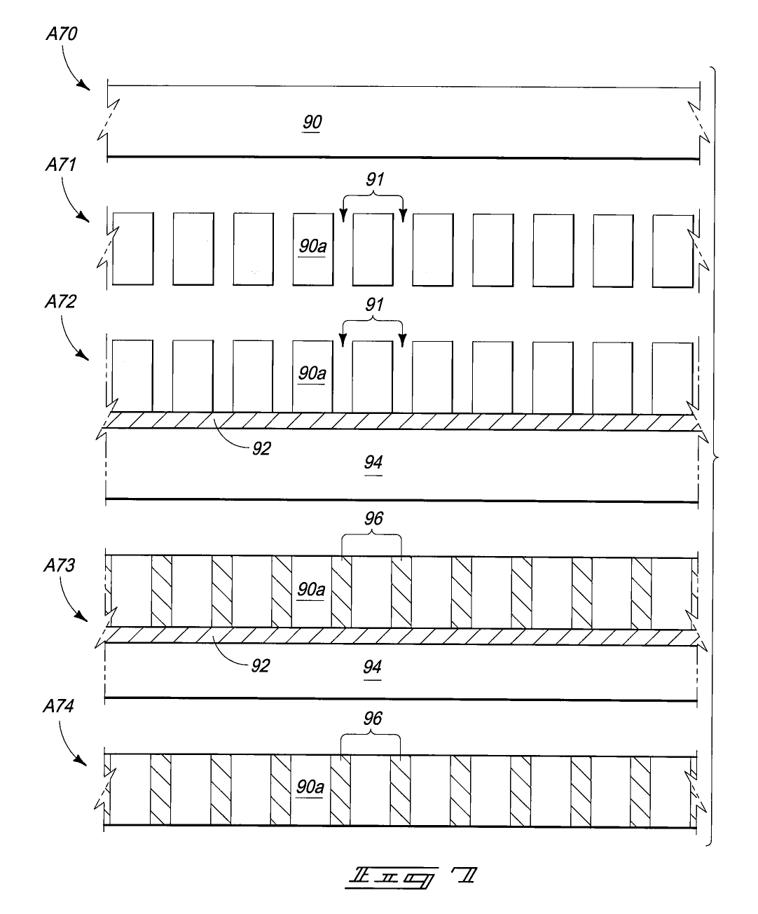

Referring to FIG. 7, the illustrated process includes providing a substrate 90 at an act A70. The substrate 90 is electrically-insulative and comprises a polymer (e.g., PET) in one embodiment.

At an act A71, substrate 90a is ablated by a laser (not shown) to form a plurality of vias 86.

At an act A72, the substrate 90a is placed upon a rigid or flexible carrier 94 (e.g., wafer or glass) which includes a metal layer 92 thereon.

At an act A73, the assembly undergoes a metal plating process (e.g., Nickel in one example) to form a plurality of electrical conductors 96 in the vias 91. The electrical conductors 96 correspond to electrical conductors 42 of FIG. 3 in one embodiment.

At an act A74, the assembly may be released from the carrier 94. The released assembly of act A74 corresponds to interconnect apparatus 40 of FIG. 3 in one embodiment. In other embodiments, additional layers of the front plane 12 may be formed upon interconnect apparatus 40 while processing occurs upon carrier 94.

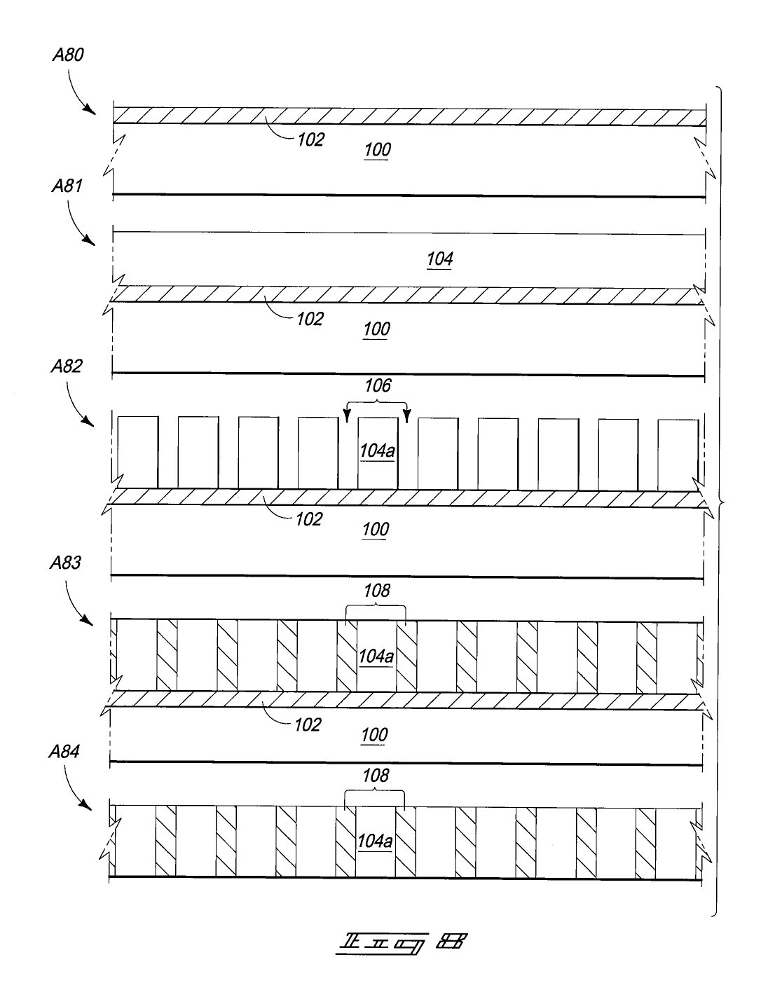

Referring to FIG. 8, the illustrated process includes applying a thin adhesive layer 102 to a carrier 100 at an act A80.

At an act A81, an electrically-insulative substrate 104 (e.g., PET) is attached to the adhesive layer 102.

At an act A82, the substrate 104a is ablated by a laser (not shown) to form a plurality of vias 106.

At an act A83, the assembly undergoes a metal plating process (e.g., Nickel in one example) to form a plurality of electrical conductors 108 in the vias 106. The electrical conductors 108 correspond to electrical conductors 42 of FIG. 3 in one embodiment.

At an act A84, the assembly may be released from the carrier 100. The released assembly of act A84 corresponds to interconnect apparatus 40 of FIG. 3 in one embodiment. In other embodiments, additional layers of the front plane 12 may be formed upon interconnect apparatus 40 while processing occurs upon carrier 100.

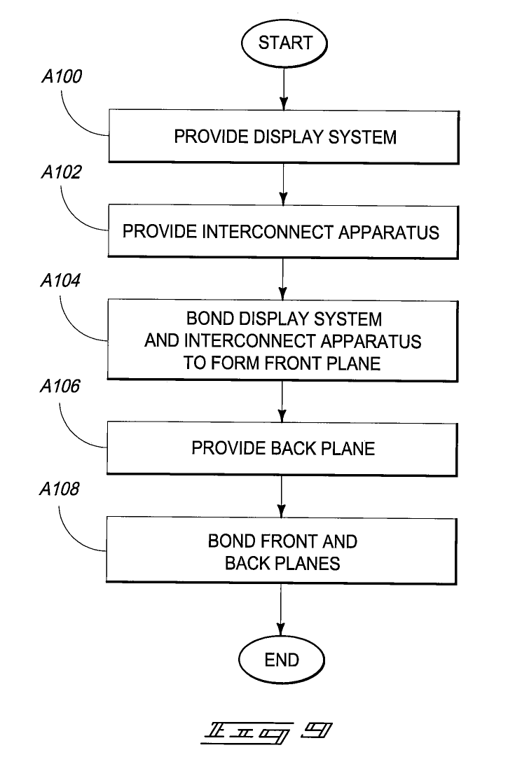

Referring to FIG. 9, a method of forming a display assembly 10 is described according to one embodiment. Other embodiments are possible which include more, less or alternative acts.

At an act A100, a display system is provided. In one embodiment, the display system is formed upon an appropriate carrier.

At an act A102, an interconnect apparatus is provided for example using one of the example processes of FIGS. 5-8.

At an act A104, the separately provided display system and the interconnect apparatus are bonded in a suitable manner, for example using an adhesive layer or the substrate (e.g., polymer) of the interconnect apparatus itself, to form a front plane. In other embodiments, one of the display system or interconnect apparatus may be formed upon the other of the display system or interconnect apparatus.

At an act A106, a back plane is provided.

At an act A108, the front plane and back planes are bonded in a suitable manner, for example using an adhesive layer or the substrate (e.g., polymer) of the interconnect apparatus itself, to form a display assembly.

According to some of the described embodiments, the front and back planes of the display assembly may be substantially completely formed separate from one another, and thereafter joined to form a display system capable of generating visual images. In one more specific example, front planes and back planes may be formed by separate entities (e.g., manufacturers) or in different facilities and thereafter joined to form the display systems. The yield of the resulting devices may be increased with at least some of the disclosed methods compared with fabrication arrangements which form structures of both the front and back planes together.

The protection sought is not to be limited to the disclosed embodiments, which are given by way of example only, but instead is to be limited only by the scope of the appended claim.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

1. A visual image display apparatus comprising:
a front plane comprising:
a display system configured to generate a plurality of visual images as a result of a plurality of electrical control signals; and
an interconnect apparatus adjacent to the display system and which comprises an electrically-insulative substrate and a plurality of electrical conductors, and wherein the electrical conductors are configured to conduct the electrical control signals with respect to the display system to control the generation of the visual images.

2. The apparatus of claim 1 wherein the interconnect apparatus comprises a through-hole interconnect comprising the electrical conductors within the electrically-insulative substrate.

3. The apparatus of claim 1 wherein the display system comprises a display volume which includes a display medium comprising a plurality of colorants which move between different portions of the display medium to generate the visual images and as a result of the electrical control signals.

4. The apparatus of claim 3 wherein the display system comprises an outer periphery which defines the display volume including a main portion and a recess portion of the display volume, and wherein the electrical control signals control the colorants to move to the recess portion of the display volume during a first optical state and to move to the main portion of the display volume during a second optical state.

5. The apparatus of claim 4 wherein the display volume comprises a plurality of recess portions, and wherein the electrical conductors are positioned adjacent to respective ones of the recess portions.

6. The apparatus of claim 5 wherein the interconnect defines the recess portions adjacent to the electrical conductors.

7. The apparatus of claim 1 further comprising a back plane coupled with the interconnect apparatus, and wherein the back plane comprises a plurality of electrical conductors coupled with the electrical conductors and which are configured to apply the electrical control signals to the electrical conductors, and wherein a pitch of at least some of the electrical conductors is less than a pitch of at least some of the electrical conductors of the back plane.

8. The apparatus of claim 1 further comprising a back plane coupled with the interconnect apparatus, and wherein the back plane comprises a plurality of electrical conductors coupled with the electrical conductors and which are configured to apply the electrical control signals to the electrical conductors, and wherein a number of the electrical conductors coupled with the electrical conductors of the back plane exceeds the number of the electrical conductors of the back plane coupled with the electrical conductors.

9. The apparatus of claim 1 wherein the front plane is an integrated structure comprising the display system and interconnect apparatus.

10. The apparatus of claim 1 wherein the display system comprises a plurality of pixels and a plurality of the electrical conductors conduct one of the electrical control signals for one of the pixels.

11. A visual image display apparatus comprising:
a display volume;
an interconnect apparatus comprising an electrically-insulative substrate and a plurality of electrical conductors; and
a display medium within the display volume which comprises a plurality of colorants which move between different portions of the display medium to generate a plurality of visual images as a result of electrical control signals conducted by the electrical conductors.

12. The apparatus of claim 11 wherein the interconnect apparatus comprises a through-hole interconnect.

13. The apparatus of claim 11 wherein the display volume comprises an outer periphery which defines a main portion and a recess portion of the display volume, and wherein the electrical control signals control the colorants to move to the recess portion of the display volume during a first optical state and to move to the main portion of the display volume during a second optical state.

14. A visual image display apparatus fabrication method comprising:
providing a display system configured to generate a plurality of visual images as a result of a plurality of electrical control signals;
coupling a plurality of electrical conductors of an interconnect apparatus and the display system and wherein the electrical conductors provide the electrical control signals to the display system to control the generation of the visual images during operation of the visual image display apparatus; and
bonding the interconnect apparatus and the display system.

15. The method of claim 14 wherein the coupling comprises coupling the electrical conductors of the interconnect apparatus comprising a through-hole interconnect.

16. The method of claim 14 wherein the providing comprises forming the display system comprising a display volume which includes a display medium comprising a plurality of colorants which move between different portions of the display medium as a result of the electrical control signals to generate the visual images.

17. The method of claim 14 wherein the display system and the interconnect apparatus form a front plane of the visual image display apparatus, and further comprising coupling a back plane with the front plane after the bonding to form the visual image display apparatus.

18. The method of claim 14 further comprising forming the interconnect apparatus comprising forming the electrical conductors within a substrate comprising electrically-insulative photoresist, and wherein the bonding comprises bonding the interconnect apparatus comprising the electrically-insulative photoresist and the electrical conductors to the display system.

19. The method of claim 14 further comprising forming the interconnect apparatus comprising:
forming an electrically-insulative substrate;
during the forming of the electrically-insulative substrate, forming a plurality of vias within the electrically-insulative substrate; and
forming the electrical conductors within the vias, and wherein the bonding comprises bonding the electrically-insulative substrate and the display system.

20. The method of claim 14 further comprising forming the interconnect apparatus comprising:
providing an electrically-insulative substrate comprising a plurality of vias over a metal layer; and
plating metal within the vias to form the electrical conductors.
